(19) United States
(12) Patent Application Publication
(10) Pub. No.: US 2002/0005908 A1
(43) Pub. Date: Jan. 17, 2002

(54) Electronic apparatus with clock and clock information storage function

(76) Inventor: Hideo Taka, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/901,626

(22) Filed: Jul. 11, 2001

(30) Foreign Application Priority Data
Jul. 13, 2000 (JP) 2000-212829

(51) Int. Cl. H04N 5/76

(52) U.S. Cl. 348/372; 348/232

(57) ABSTRACT

An electronic apparatus, particularly a camera, includes a clock signal circuit that generates a clock signal at a predetermined cycle, and a non-volatile memory circuit for counting clock signal pulses generated by the clock signal circuit and storing the counted signals.

### BACKGROUND OF THE INVENTION

1. Field of the Invention

The present invention relates to time-keepers used in electronic apparatuses such as cameras for capturing photographs and digital images.

2. Description of the Related Art

Conventional time-keepers, which are used in cameras for keeping track of date data receive power from batteries. When the batteries are replaced, time-keeping data maintained up until that time is lost. A user is therefore required to reconfigure the date and clock data.

Japanese Laid-Open Patent No. 6-250278 describes a camera in which reconfiguration of date and clock data, which occurs when batteries are replaced, is facilitated. In this camera, information for keeping track of the date is written in a non-volatile memory when a battery is replaced. For example, when the “day” changes, this time-keeping information is written in the non-volatile memory. When a new battery is attached, the time-keeping information stored in the non-volatile memory is read out, and the information read out is used as initial date and clock data.

In the foregoing example, a battery removal detector for detecting when a battery is removed is required. The battery removal detector is provided in order to write information for keeping track of the date in the non-volatile memory when the battery is removed. Also, a power supply backup is required for ensuring the writing of time-keeping information to the non-volatile memory in a state in which the battery is removed. This results in an increase in the size of the camera and an increase in the cost.

When time-keeping information is written in the non-volatile memory as the time-keeping information advances, an additional device is unnecessary. As it is assumed that EEPROM (electrically erasable/programmable read only memory) is used as the non-volatile memory, the number of times that the EEPROM can be rewritten is limited. Since writing to the non-volatile memory is performed only when “day” data advances, the user is required to correct the time-keeping information when a battery is actually replaced.

The limitation on the number of times that the EEPROM can be rewritten will now be described in detail. A high voltage is used to rewrite the EEPROM. Taking into consideration the reliability of memory devices, the number of times that the EEPROM can be rewritten is generally limited to ten thousand to one hundred thousand times. If it is assumed that the camera has an operating life of ten years and that rewriting is performed once a day, the number of times that the EEPROM is rewritten is 365×10=3650. One minute is required to replace a battery. In order to eliminate the necessity of having to correct the time subsequent to the battery replacement, it is necessary to perform rewriting once a minute. In this case, the number of times that the EEPROM is rewritten is 60×24×365×10=5256000, which exceeds the limit of the number of times it can be rewritten.

In the foregoing example, when a battery is replaced, an additional non-volatile memory, which is different from that used in a time-keeper for counting time-keeping information, is required for a backup. Thus, the structure becomes more complicated. Also, a backup program other than a time-keeping program is necessary.

### SUMMARY OF THE INVENTION

Accordingly, it is an object of the present invention to store time-keeping information when a battery is replaced, without using a backup non-volatile memory different from that used in a time-keeper.

It is another object of the present invention to record the time-keeping contents of the time-keeper in a recording medium or to display the time-keeping contents on a display unit.

It is another object of the preset invention to reconcile the contents of the time-keeper with the actual time after a battery is replaced.

According to one aspect of the present invention, an electronic apparatus is provided including a clock circuit for generating a clock signal on a predetermined cycle; and a non-volatile memory circuit for counting the clock signals generated by the clock circuit and storing the counted signals.

Preferably, the non-volatile memory circuit is a ferroelectric memory.

The electronic apparatus may further include a control circuit for controlling the electronic apparatus. The control circuit may cause the non-volatile memory circuit to count the clock signals in response to the clock signals generated by the clock circuit.

The electronic apparatus may be a camera.

The control circuit may be a central processing unit (CPU).

When a power supply battery for supplying power to the electronic apparatus is replaced, the non-volatile memory circuit may start counting in a state in which a predetermined value is added to the memory contents of the non-volatile memory circuit.

According to another aspect of the present invention, an electronic apparatus is provided including a time-keeping circuit for keeping time; and a ferroelectric memory circuit for storing a time signal concerning time kept by the time-keeping circuit.

According to the present invention, a ferroelectric memory, which can be rewritten many more times than EEPROM or the like, is used as a non-volatile memory in a time-keeper. Thus, the size of an electronic apparatus such as a camera is not increased; nor is the cost increased. It is also possible to store time-keeping information at the time a battery is replaced, without using a backup non-volatile memory different from that used in the time-keeper.

Further objects, features and advantages of the present invention will become apparent from the following description of the preferred embodiments with reference to the attached drawings.

### BRIEF DESCRIPTION OF THE DRAWINGS

FIG. 1 is a schematic circuit block diagram of an electronic apparatus according to a first embodiment of the present invention;

FIG. 2 is a flowchart showing the operation of the electronic apparatus shown in FIG. 1; and

FIG. 3 is a flowchart showing the operation according to a second embodiment of the present invention.

### DESCRIPTION OF THE PREFERRED EMBODIMENTS

First Embodiment

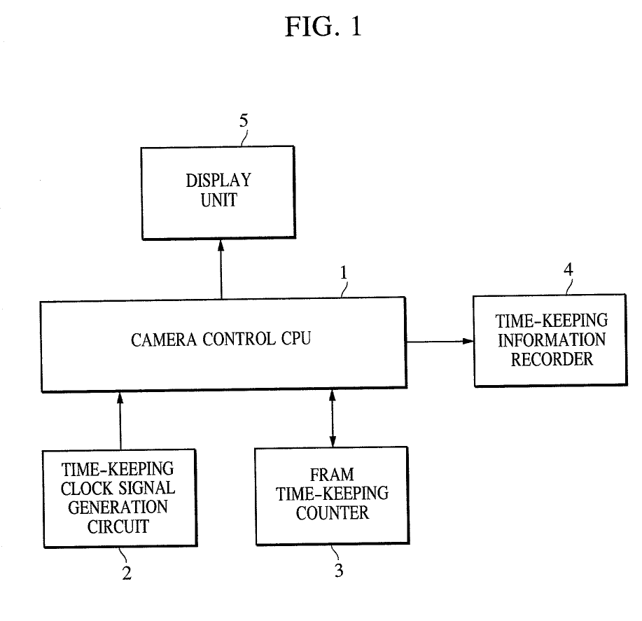

FIG. 1 schematically shows the structure of a camera, which is an example of an electronic apparatus according to a first embodiment of the present invention.

Referring to FIG. 1, the camera includes a camera control central processing unit (CPU) 1, which is a control circuit. A time-keeping clock signal generation circuit 2 generally divides the output of a crystal-oscillator circuit and supplies an output (signal pulse) every second (1 Hz) to the camera control CPU 1. In response to a command given from the camera control CPU 1, a time-keeper 3 counts time-keeping information, that is, keeps time data including second, minute, hour, day, month, and year. The time-keeper 3 counts the time-keeping information (second signal pulses in the case of 1 Hz) in synchronization with the output from the time-keeping clock signal generation circuit 2. The time-keeper 3 supplies the time-keeping contents to the camera control CPU 1. The time-keeper 3 is a ferroelectric memory (hereinafter referred to as “FRAM”) time-keeping counter which uses FRAM as a non-volatile memory. A time-keeping information recorder 4 magnetically or optically records the time-keeping information at the time a release operation is performed for recording information on/in a recording medium, such as a film. A display unit 5 displays the time-keeping contents.

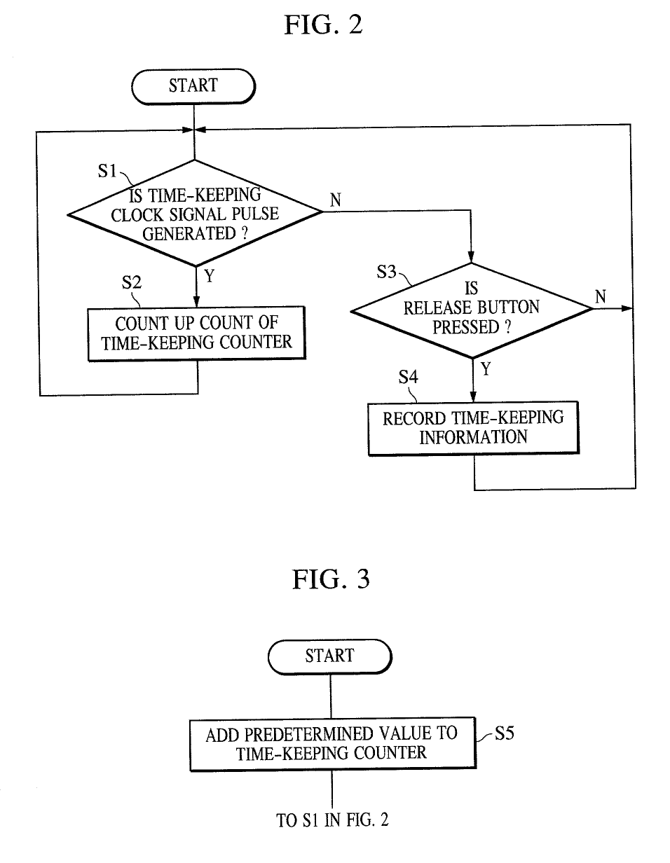

FIG. 2 is a flowchart showing a process performed by the camera control CPU 1 of the electronic apparatus shown in FIG. 1.

Referring to FIG. 2, the process determines whether or not a time-keeping clock signal pulse has been generated by the time-keeping clock signal generation circuit 2. As described above, it is assumed that one time-keeping clock's signal pulse is sent per second. When the time-keeping clock signal pulse is generated, the process proceeds to step S2. When no time-keeping clock signal pulse is generated, the process proceeds to step S3. In step S2, since the generation of the time-keeping clock signal pulse by the time-keeping clock signal generation circuit 2 is detected, the process counts up the count of the FRAM time-keeping counter 3. If the time-keeping clock signal is a pulse signal at 1 Hz, the FRAM time-keeping counter 3 includes a second counter, a minute counter, an hour counter, a day counter, a month counter, and a year counter. If the counting up of the count of the FRAM time-keeping counter 3 is completed in step S2, the process returns to step S1. In step S3, since the generation of the time-keeping clock signal by the time-keeping clock signal generation circuit 2 is not detected, the process determines whether or not a release button (not shown) has been pressed. If the determination is affirmative, the process proceeds to step S4. If the determination is negative, the process returns to step S1. In step S4, since the release button has been pressed, the process captures a photograph or an image and records time-keeping information such as date and time at which the photograph or the image is captured on a recording medium, such as a film.

As described above, the FRAM time-keeping counter 3 is constantly updated. When a battery is replaced, the time-keeping information at the time the battery is replaced is stored every second. Even when battery replacement requires approximately one minute, the time-keeping contents of the FRAM time-keeping counter 3 substantially represent the correct time. As a result, it is rarely necessary to adjust the time.

Second Embodiment

FIG. 3 shows a control flow according to a second embodiment of the present invention. The normal operation performed in the second embodiment is shown in FIG. 2. FIG. 3 is a flowchart showing a process performed subsequent to battery replacement.

When a battery is replaced while the normal operation shown in FIG. 2 is being performed, the time-keeping contents at that time are stored in the FRAM time-keeping counter 3. When the battery is replaced, the camera control CPU 1 starts the process shown in FIG. 3. In step S5, the process adds a predetermined value to the FRAM time-keeping counter 3. The predetermined value is the period required to replace the battery. For example, data indicating one minute is added. Subsequently, the process returns to step S1 in FIG. 2, and normal operation is resumed.

In the second embodiment, the amount of time expected for replacing the battery is added to the FRAM time-keeping counter 3. After the battery is replaced, time is marked based on the more accurate time-keeping data.

As described above, in the present invention, a FRAM is used as the non-volatile memory for storing time-keeping information. One feature of the FRAM is that it can be rewritten many more times than an EEPROM. In general, the number of times that a FRAM can be rewritten ranges from ten billion to one trillion. If the operating life of the camera is ten years, and if the FRAM is rewritten every second, the total number of times that the FRAM is rewritten is 60×60×24×365×10, that is, approximately 300 million. With a FRAM, the number of times that the FRAM is rewritten is within the limits, even when reliability is taken into consideration.

Although a camera with an operating life of ten years and a time-keeping clock signal pulse frequency of 1 Hz has been described in the above preferred embodiments, the operating life and the time-keeping clock signal pulse frequency are not limited to those described in these embodiments. For example, within the limits of the number of times that the FRAM can be rewritten, the operating life and the time-keeping clock can be measured in minute units.

Although it is described in the above preferred embodiments that the FRAM time-keeping counter, which is a time-keeper, is used as a device independent of the camera control CPU consisting of a microcomputer, the structure is not limited to that described in the embodiments. For example, the FRAM itself can be a program memory or a RAM of a microcomputer so that everything can be configured as one chip. When a RAM using a FRAM is used as a time-keeper, program steps can be utilized more efficiently.

When a film camera is used, time-keeping information is optically or magnetically recorded on a film. When the present invention is applied to a digital camera, time-keeping information can be recorded, together with image information, in an image recording medium such as CompactFlash (™) or the like.

Although a camera has been described as an example in the above preferred embodiments, the present invention can be applied to other apparatuses which keep time and receive power from a power supply such as a battery.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An electronic apparatus comprising:
a clock circuit that generates a clock signal having clock signal pulses generated at a predetermined cycle; and
a non-volatile memory circuit that counts clock signal pulses generated by said clock circuit and stores the counted clock signal pulses.

2. An electronic apparatus according to claim 1, wherein said non-volatile memory circuit comprises a ferroelectric memory.

3. An electronic apparatus according to claim 1, further comprising a control circuit that controls said electronic apparatus, wherein said control circuit controls said non-volatile memory circuit so as to count the clock signal pulses in response to the clock signal generated by said clock signal circuit.

4. An electronic apparatus according to claim 1, wherein said electronic apparatus comprises a camera.

5. An electronic apparatus according to claim 4, wherein said control circuit comprises a central processing unit.

6. An electronic apparatus according to claim 1, wherein, when a power supply battery for supplying power to said electronic apparatus is replaced, said non-volatile memory circuit starts counting in a state in which a predetermined value is added to the memory contents of said non-volatile memory circuit.

7. An electronic apparatus comprising:
a time-keeping circuit that keeps time; and
a ferroelectric memory circuit that stores a time signal concerning time kept by said time-keeping circuit.

8. An electronic apparatus according to claim 7, further comprising a control circuit that controls the electronic apparatus, wherein said control circuit controls said ferroelectric memory circuit so as to store the time signal for said time-keeping circuit in response to time-keeping by said time-keeping circuit.

9. An electronic apparatus according to claim 7, wherein said electronic apparatus comprises a camera.

10. An electronic apparatus according to claim 7, wherein said control circuit comprises a central processing unit.
